(19) United States
(12) Patent Application Publication
(10) Pub. No.: US 2022/0155790 A1
(43) Pub. Date: May 19, 2022

(54) INTEGRATED MANAGEMENT SYSTEM

(71) Applicant: Shimizu Corporation, Tokyo (JP)

(72) Inventors: Yuji KINOSHITA, Tokyo (JP); Syunsuke IGARASHI, Tokyo (JP); Taku TANI, Tokyo (JP)

(73) Assignee: Shimizu Corporation, Tokyo (JP)

(21) Appl. No.: 17/598,888

(22) PCT Filed: May 20, 2019
(86) PCT No.: PCT/JP2019/019981

§ 371 Date: Sep. 28, 2021

(30) Foreign Application Priority Data
Apr. 9, 2019 (JP) 2019-074256

(51) Int. Cl. G05D 1/02

(52) U.S. Cl. CPC G05D 1/0217; G05D 2201/0216

(57) ABSTRACT

An integrated management system manages an operation of a moving body capable of moving autonomously and deployed in an area, and includes: a route map virtually plotted to the area, the route map including two or more nodes and one or more edges each connecting the nodes; and a processor configured to set a route for causing the moving body to move from one of the nodes to another one of the nodes designated as a destination via at least one of the edges, and control the moving body to move along the route.

### FIELD

The present invention relates to an integrated management system suitable for managing a large number of transport carts and transport robots that are used for transporting materials in a building construction site, for example.

### BACKGROUND

Conventionally, automated transport carts have been sometimes used to transport materials in a building construction site, for example. As a traveling method of the automated transport cart, for example, a method for detecting guide rails laid on the floor, and causing the automated cart to travel along the guide rails. In material registrations for the automated transport carts, services of carts are managed using address markers or the like, for the purpose of managing the destinations of transportation when the materials are to be transported (for example, see Patent Literature 1). However, in order to change the layout of the construction site, reinstallations of the guide rails, the address markers, and the like have been required. Therefore, there has been a demand for a technique for enabling a layout change without any cumbersome physical labors.

As a conventional technique for addressing such an issue, a technique disclosed in Patent Literature 2 has been known, for example. According to the disclosure in Patent Literature 2, an image capturing device for capturing a video of a work floor is installed above the work floor, at an angle perpendicular to the floor surface, and the positions of self-propelled carts, loads, and obstacles are recognized from the video. A route generator is then caused to generate appropriate routes, and the self-propelled carts are controlled based on the routes. This control is achieved by causing a controller computer to sequentially keep providing the self-propelled cart with an instruction of a next sub-goal that is closer to the goal than the current position of the self-propelled cart is.

The applicant of the present patent application has already disclosed an integrated management system according to Patent Literature 3. A system disclosed in

Patent Literature 3 is a system that is used in a construction site, and that integrally manages a transport robot configured to transport a material, and a construction robot configured to execute a construction task using the material. This system includes a transport robot managing unit for controlling and managing transport operations performed by at least one transport robot, using a wireless or wired communication unit, and a construction robot managing unit for controlling and managing construction operations performed by at least one construction robot, using a wireless or wired communication unit.

### CITATION LIST

### Patent Literature

Patent Literature 1: Japanese Patent Application Laid-open No. 2000-3500

Patent Literature 2: Japanese Patent Application Laid-open No. H9-230933

Patent Literature 3: Japanese Patent Application Laid-open No. 2017-228101

### SUMMARY

### Technical Problem

However, the conventional technique disclosed in Patent Literature 2 sets the routes for the self-propelled carts by recognizing the positions of the self-propelled carts, loads, and obstacles from a video of a work floor. Therefore, when there is a blind spot, it makes the recognition difficult, and the routes cannot be set appropriately. Meanwhile, if a larger number of the image capturing devices are installed to reduce the blind spot, the cost may increase. Furthermore, advanced and complicated image analysis and coordinate conversion processing are required in order to recognize a position from the video. Therefore, there has been a demand for a technique that can easily set a route for moving bodies, such as carts.

The present invention is made in view of the above, and an object of the present invention is to provide an integrated management system capable of easily setting a moving route for moving bodies.

### Solution to Problem

To solve the above-described problem and achieve the object, an integrated management system according to the present invention manages an operation of a moving body capable of moving autonomously and deployed in an area, and includes: a route map virtually plotted to the area, the route map including two or more nodes and an edge connecting the nodes; a route setting unit configured to set a route for causing a moving body to move from a node to a destination node via at least one edge; and a control unit configured to control the moving body to move along the set route.

Moreover, in the above-described integrated management system according to the present invention, the control unit is configured to generate command information for causing the moving body to move along the set route, and the moving body is configured to start moving based on the received command information and move along the route.

Moreover, in the above-described integrated management system according to the present invention, the control unit is configured to generate movement command information for causing the moving body to move along the set route, and operation command information for causing the moving body to make an operation at a predetermined node or a predetermined edge, and the moving body is configured to receive the movement command information and the operation command information, start moving based on the movement command information, and move along the route, whereas the moving body is configured to operate based on the operation command information at the predetermined node or the predetermined edge.

Moreover, in the above-described integrated management system according to the present invention, the route setting unit is configured to select a route that minimizes the distance or the time of movement from a plurality of routes.

Moreover, in the above-described integrated management system according to the present invention, the moving body is a transport robot configured to transport a load, and configured to be controlled to move from a node indicating a location of a transport source, to a node indicating a location of a transport destination.

### Advantageous Effects of Invention

The integrated management system according to the present invention is an integrated management system for managing an operation of a moving body that is deployed in an area and capable of moving autonomously, including: a route map that is virtually plotted to the area, and that includes two or more nodes and an edge connecting the nodes; a route setting unit that sets a route for causing a moving body to move from a node to a destination node via at least one edge; and a control unit that controls the moving body to move along the set route. Therefore, a moving route for a moving body can be easily set, advantageously.

Furthermore, with another integrated management system according to the present invention, because the control unit generates command information for causing the moving body to move along a set route, and the moving body starts moving based on the received command information and moves along the route, it is possible to cause the moving body to move along the route, advantageously.

Furthermore, with another integrated management system according to the present invention, because the control unit generates movement command information for causing the moving body to move along a set route, and operation command information for causing the moving body to make an operation at a predetermined node or a predetermined edge; the moving body receives the movement command information and the operation command information, starts moving based on the movement command information, and moves along the route, whereas the moving body operates based on the operation command information at the predetermined node or the predetermined edge, it is possible to cause the moving body to move along the route, and to cause the moving body perform a predetermined operation at the predetermined node or the predetermined edge, advantageously.

Furthermore, with another integrated management system according to the present invention, because the route setting unit selects a route that minimizes the distance or the time of the movement from a plurality of routes, it is possible to cause the moving body to move along a route that minimizes the distance or the time of the movement, advantageously.

Furthermore, with another integrated management system according to the present invention, because the moving body is a transport robot that transports a load, and is controlled to move from a node indicating a location of a transport source, to a node indicating a location of a transport destination, it is possible to cause the moving body to transport a load from the transport source to the transport destination, advantageously.

### BRIEF DESCRIPTION OF DRAWINGS

FIG. 1 is a schematic block diagram for illustrating an integrated management system according to an embodiment of the present invention.

FIG. 2 is an explanatory diagram of a relation between a route map and a yard.

FIG. 3 is an explanatory diagram of a yard including a collection of a plurality of material blocks.

FIG. 4 is an explanatory diagram of a relation between the material block and an approach node.

FIG. 5 is a diagram for illustrating one example of a set route map.

FIG. 6 is a diagram for illustrating one example of a route setting sequence.

### DESCRIPTION OF EMBODIMENTS

An integrated management system according to an embodiment of the present invention will now be explained in detail with reference to the drawings. This embodiment is, however, not intended to limit the scope of the present invention in any way.

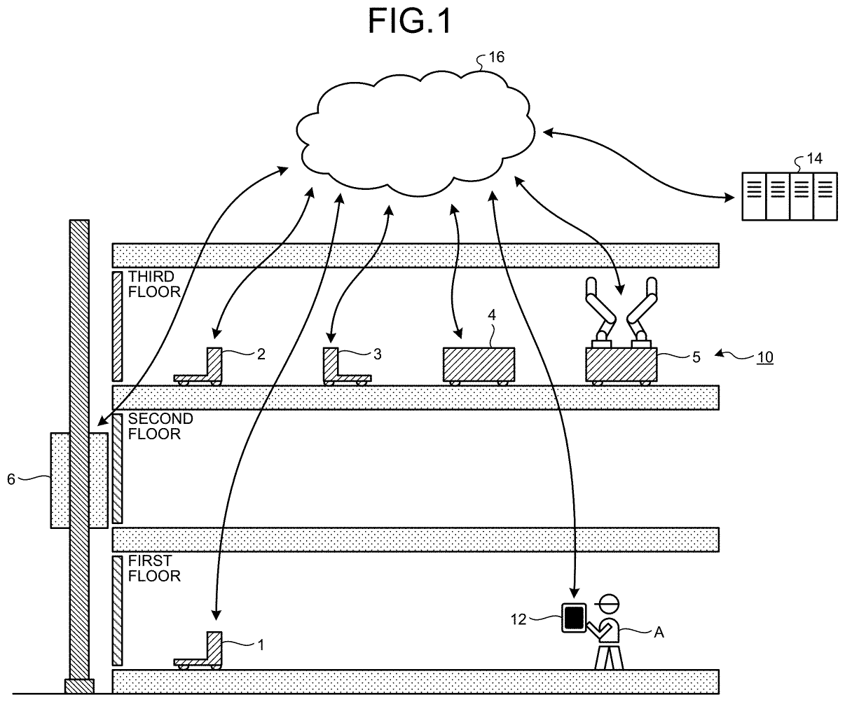

As illustrated in FIG. 1, an integrated management system 10 according to the embodiment is used in a building construction site composed of a plurality of floors (areas). A horizontal transport cart 1 is deployed on the first floor, and horizontal transport carts 2 and 3, a delivering cart 4, and a work robot 5 are deployed on the third floor. On the left end of the building, an elevator/lift 6 for transporting materials is installed. The elevator/lift 6 has an automated door, not illustrated.

The horizontal transport carts 1 to 3 and the delivering cart 4 are transport robots (moving bodies capable of autonomously moving). The horizontal transport carts 1 to 3 are carts that travel horizontally on the floor, and transport materials (load). The horizontal transport cart 1 moves reciprocally between the elevator/lift 6 and a material storage area not illustrated, for example, on the first floor. The horizontal transport carts 2 and 3 move reciprocally between the elevator/lift 6 and a material storage area (not illustrated), for example, on the third floor. The delivering cart 4 is a cart for delivering the materials to the work robot 5, and the work robot 5 is a construction robot.

A management terminal 12 can input work instruction information, such as materials to be transported, the order of transportation, destination floors, and the order of construction, and give work instructions to various types of the automated machines described above based on the inputs, via the Internet 16 and a management server 14. The management terminal 12 may be implemented as a portable tablet terminal, for example. In the example illustrated in FIG. 1, a work supervisor A who is on the first floor carries the management terminal 12.

The management server 14 stores therein, in addition to a route map, which will be described later, drawing data, material data, transportation data, construction data, and work status data, and these pieces of data can be transmitted to and received from the various automated machines described above in a timely manner via the Internet 16. The drawing data includes, in addition to the building shape data for each floor, information of initial positions of the transport robots, such as the horizontal transport carts 1 to 3 and the delivering cart 4, the location where the elevator/lift 6 is installed, the material storage areas and the like. The material data is data including information of the types, the dimensions, the weights, and the quantities of materials. The transportation data is data including information of the order in which the materials are transported, the location and the floor of the temporary storage where the materials are stored, and the location and the floor of a destination temporary storage, and the transportation data is associated with the material data. The construction data is data including information of the order, the location, the floor, and the coordinates of where the construction materials are to be mounted, and the construction data is associated with the material data. The work status data is information of the current status of the transport robots, such as the horizontal transport carts 1 to 3 and the delivering cart 4, the elevator/lift 6, and the work robot 5. The work status data for a transport robot includes information of its current position, velocity, the presence of loaded materials, and its weight measurement. The work status data for the elevator/lift 6 includes information of the position of the bucket, information of the loaded materials, its weight measurement, and the opening or closing status of the door. The work status data for the work robot 5 includes information of the position where the robot is involved in a construction, the presence of a material, the work status such as holding or mounting, and the weight measurement of the material.

Temporary mechanical facilities, such as the horizontal transport carts 1, 2 and 3, the delivering cart 4, the work robot 5, and the elevator/lift 6, the management terminal 12, and the management server 14 are interconnected to the Internet 16 via a wireless or a wired communication network. The management server 14 can perform data communication with the horizontal transport carts 1 to 3, the delivering cart 4, the work robot 5, the elevator/lift 6, and the management terminal 12 in the locations where these units are in operations, over the Internet 16, and is capable of transmitting and receiving various types of data such as instructions and reports. In this manner, by managing the construction status and the various automated machines (such as the horizontal transport cart 1, 2 and 3, the delivering cart 4, the work robot 5, and the elevator/lift 6) on the construction site in an integrated manner using the integrated management system 10, each of these machines can be caused to cooperate with one another, and to achieve automation of the process from the transport to the constructions.

The horizontal transport carts 1 to 3 and the delivering cart 4 can autonomously travel using a laser self-localization system, such as simultaneous localization and mapping (SLAM), based on the drawing data, and transport materials in the order instructed by the management terminal 12, from a material storage area to the elevator/lift 6, or from the elevator/lift 6 to a material storage area.

The elevator/lift 6 can open and close the door automatically based on building material loading or unloading information received from the horizontal transport carts 1 to 3, and move to the destination floor as instructed by the management terminal 12 to move to a loading floor after unloading the material.

The work robot 5 (construction robot) can autonomously travel based on the drawing data using SLAM and executing tasks such as mounting, constructing, or the like with the materials in the designated location, based on the order of construction tasks instructed by the management terminal 12.

With the integrated management system 10 configured in the manner described above, the horizontal transport cart 1 loads materials to be delivered onto the elevator/lift 6, and the elevator/lift 6 moves the materials to the floor where the materials are to be used in constructions. The horizontal transport carts 2 and 3 then unload the materials from the elevator/lift 6, and the horizontal transport carts 2 and 3 and the delivering cart 4 transport the materials to the material storage area.

The integrated management system 10 then performs a series of control management tasks for causing the work robot 5 to execute construction tasks using the transported materials.

This integrated management system 10 includes a route map, a route setting unit, and a control unit that controls the operations of the horizontal transport carts 1, 2 and 3, the delivering cart 4, the work robot 5, and the elevator/lift 6. The control unit and the route setting unit are stored in the management terminal 12 and the management server 14.

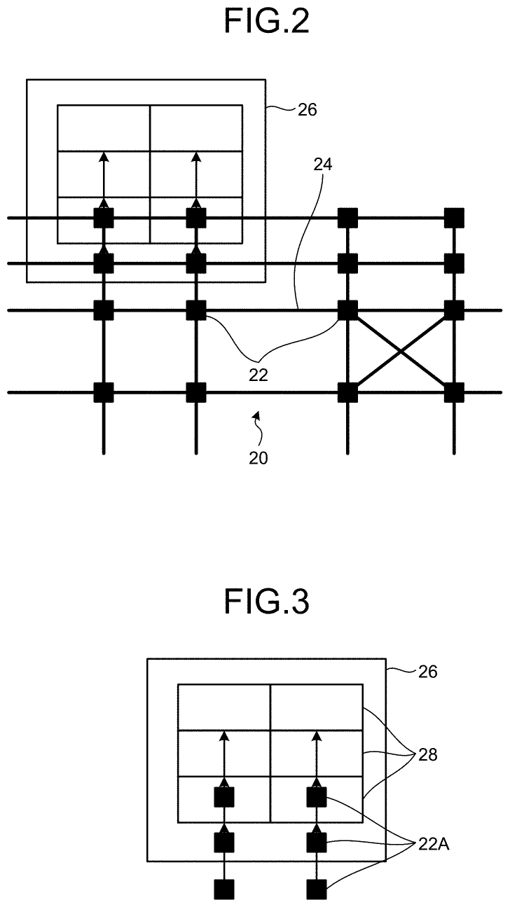

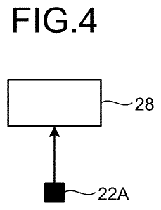

As illustrated in FIG. 2, a route map 20 is a virtual map plotted and registered to the surface of each floor, using known drawing data as a reference, and is stored in the management server 14. The route map 20 includes nodes 22 that are the nodes of a network, and edges 24 (sides) connecting the nodes 22. The edges 24 are plotted to locations where passage is permitted, by avoiding obstacles such as pillars. The route map 20 is connected to a yard 26 including a collection of material storage areas, via predetermined nodes 22. As illustrated in FIG. 3, a plurality of material blocks 28 defined and ensured as material storage areas are arranged inside the yard 26. The yard 26 is associated with the materials placed in the material blocks 28. As illustrated in FIG. 4, an approach node 22A is set near each material block 28. The approach node 22A is a node that indicates the node for approaching the material block 28 to collect the load and the like.

Each material block 28 may be set with a purpose. For example, each material block 28 can be set as, in addition to a material block for a material storage area, a material block for an elevator/lift for performing tasks in an area in front of the elevator/lift, a material block for a waiting area, and a material block for a charging power area. A material block for a material storage area can be set based on the size of the material, for example. For example, a material block having a length of 2.2 meters and a width of 1.1 meters may be used for a short object, and a material block including a concatenation of two of such material blocks, that is, a material block having a length of 4.4 meters and a width of 1.1 meters may be used for a long object. Each node 22 may also be set with a purpose. For example, in addition to ordinary nodes making up a route map 20 and approach nodes 22A described above, a node may be set as a material block node for indicating the position and the type of a material block 28.

The route setting unit is for setting a route for enabling each of the carts 1 to 4 to move from a predetermined node 22 (starting point) to a destination node 22 (destination point) via some edges 24. For example, a material block node indicating a material block for a waiting area may be designated as a starting-point node 22, and an approach node 22A may be designated as a destination-point node 22. A node 22 corresponding to the yard 26 may also be designated as the destination-point. The route setting unit sets a route based on the route map 20 stored in the management server 14, and route setting information input from the management terminal 12. The route setting unit may select a route that minimizes the distance or the time of the movement, among a plurality of route candidates. In this manner, it is possible to cause each of the carts 1 to 4 to move along a route that minimizes the distance or the time of movement.

The control unit controls to cause each of the carts 1 to 4 to move along a set route, and controls to cause each of the carts 1 to 4 to perform a predetermined operation at the predetermined node 22 or the predetermined edge 24. Specifically, the control unit generates movement command information for causing each of the carts 1 to 4 to move along a set route, and operation command information for causing each of the carts 1 to 4 to perform a predetermined operation when each of the carts 1 to 4 is positioned at the predetermined node 22 or the predetermined edge 24 having been preset. Each of the carts 1 to 4 receives the movement command information and the operation command information via the Internet 16, starts moving based on the movement command information, and moves along their routes. In this manner, it is possible to transport a material from a transport source to a transport destination.

At the predetermined node 22 or the predetermined edge 24, each of the carts 1 to 4 makes an operation based on the operation command information. For example, when each of the carts 1 to 4 arrives at the approach node 22A, each of the carts 1 to 4 may be caused to perform an approaching operation such as picking up a material from a corresponding material block 28, or placing a material to the corresponding material block 28. Furthermore, when each of the carts 1 to 4 arrives at the node 22 corresponding to the yard 26, each of the carts 1 to 4 may be caused to place or to pick up materials one after another from the material block 28 located at an end of the yard 26. Each of the carts 1 to 4 may also be caused to face a predetermined direction (e.g., forward) at the edge 24 where there is an approach node 22A in front thereof in the travelling direction. At the position of the predetermined node 22, each of the carts 1 to 4 may be caused to set the operations so as to be rotatable or not rotatable.

One example of a route setting and transporting sequence using the embodiment will now be explained.

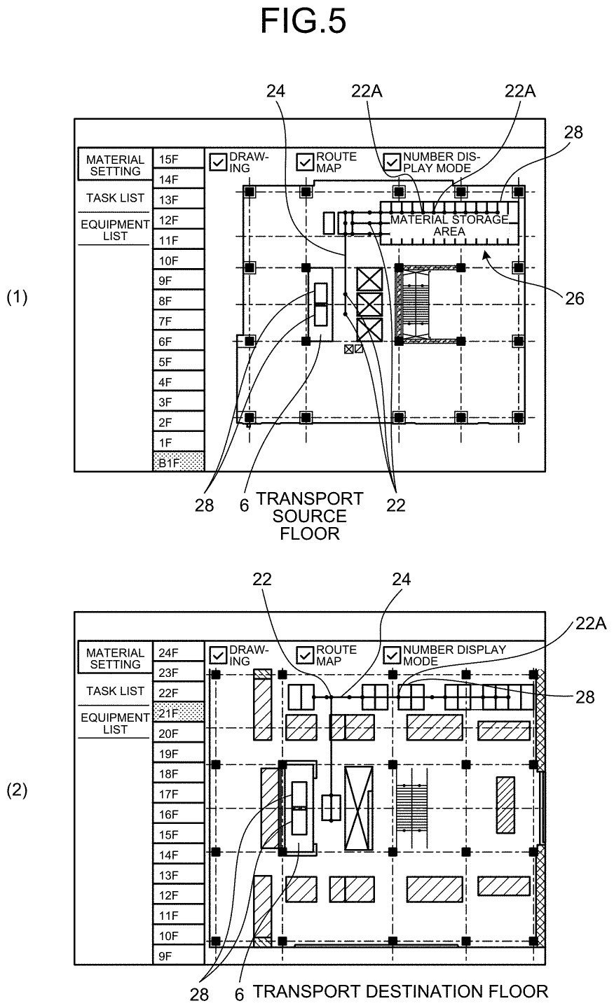

To begin with, a route map is set and registered in advance. FIG. 5 is an example of a set route map, where (1) is a transport source floor (the first basement floor), and (2) is a transport destination floor (the twenty-first floor).

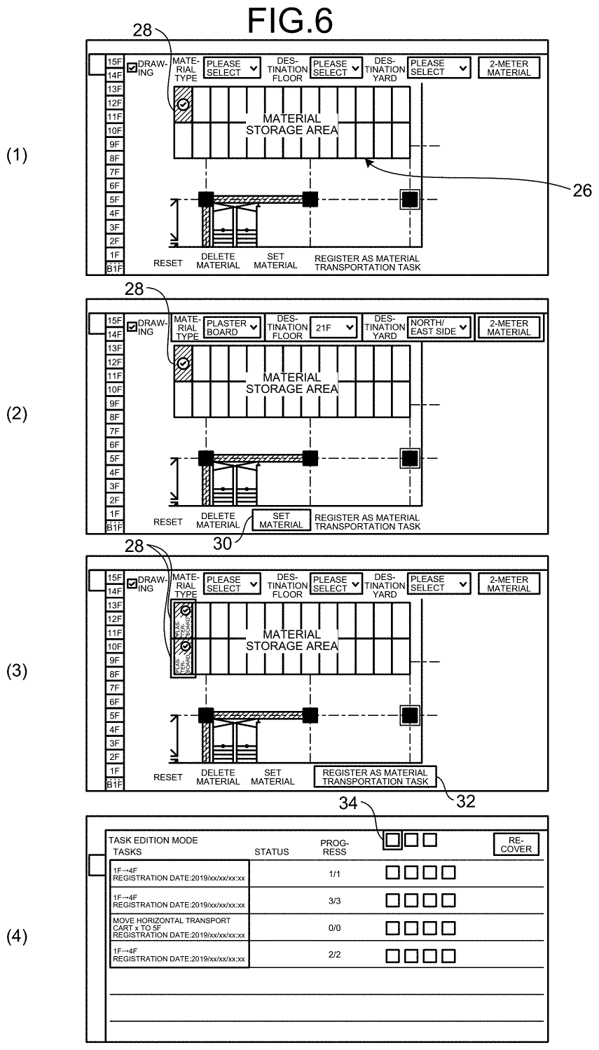

In the screen displayed on the management terminal 12, as illustrated in FIG. 6(1), a material block 28 in the yard 26 (material storage area) on the transport source floor is selected. Material information is then set by selecting “material type”, “destination floor”, “destination yard”, and “material size” of the transport destination floor displayed at the top of the screen, as illustrated in FIG. 6(2), and pressing a button 30. It is assumed herein that each of the carts is set to make operations to place the materials one after another, starting from the material block 28 located at an end of the yard 26 designated as the destination yard. A plurality of material blocks 28 are then selected from those having been already registered in the material information, and pressing a button 32 to input as a transportation task, as illustrated in FIG. 6(3). Finally, a plurality of transportation tasks are selected, and the transport is started by pressing a transport start button 34, as illustrated in FIG. 6(4). In the manner described above, transportation tasks are assembled by the route setting unit and the control unit in the management terminal 12, and the command information is transmitted to the management server 14 via the Internet 16. The management server 14 transmits the command information to each of the carts 1 to 4 via the Internet 16, and each of the carts 1 to 4 starts the transport operations. The status of each of the carts is transmitted to the management server 14 via the Internet 16, at a predetermined time interval (at an increment of one second, for example). It is preferable for status completion notification information to be transmitted to the management server 14 at each small step of the task.

In the manner described above, in this embodiment, traveling routes for each of the carts 1 to 4 can be easily set using the management terminal 12 and the management server 14. Furthermore, because the route map 20 is set and registered in the management server 14, and each of the carts 1 to 4 autonomously travels using a laser self-localization system such as the SLAM, it is not necessary to lay objects such as guide rails or tapes in the real space. Therefore, the layout of the traveling routes can be easily changed. Hence, flexible operations of a route plan are made possible. Furthermore, because, when a yard 26 is designated as a transport destination, materials are placed one after another from an end of the material block 28 in the yard 26, it is not necessary to designate a transport destination for every material. By simplifying a material registration, operability is improved, and it is possible to simplify the operation of the system on a construction site where a large number of unspecified workers are involved in labors.

As described above, the integrated management system according to the present invention is an integrated management system for managing an operation of a moving body that is deployed in an area and capable of moving autonomously, the integrated management system including a route map that is virtually plotted to the area, and that includes two or more nodes and an edge connecting the nodes; a route setting unit that sets a route for causing the moving body to move from a node to a destination node via at least one edge; and a control unit that controls the moving body to move along the set route. Therefore, a moving route for a moving body can be easily set.

Furthermore, with another integrated management system according to the present invention, because the control unit generates command information for causing the moving body to move along a set route, and the moving body starts moving based on the received command information and moves along the route, it is possible to cause the moving body to move along the route.

Furthermore, with another integrated management system according to the present invention, because the control unit generates movement command information for causing the moving body to move along a set route, and operation command information for causing the moving body to make an operation at a predetermined node or a predetermined edge; the moving body receives the movement command information and the operation command information, starts moving based on the movement command information, and moves along the route, whereas the moving body operates based on the operation command information at the predetermined node or the predetermined edge, it is therefore possible to cause the moving body to move along the route, and to cause the moving body perform a predetermined operation at the predetermined node or the predetermined edge.

Furthermore, with another integrated management system according to the present invention, because the route setting unit selects a route that minimizes the distance or the time of movement from a plurality of routes, it is possible to cause the moving body to move along a route that minimizes the distance or the time of the movement.

Furthermore, with another integrated management system according to the present invention, because the moving body is a transport robot that transports a load, and is controlled to move from a node indicating a location of a transport source, to a node indicating a location of a transport destination, it is possible to cause a moving body to transport a load from the transport source to the transport destination.

### INDUSTRIAL APPLICABILITY

As described above, the integrated management system according to the present invention is useful in managing transportations by a transport cart that transports a material in a building construction site or a factory, and is particularly suitable for facilitating the setting of a traveling route for a transport cart.

### REFERENCE SIGNS LIST

1, 2, 3 Horizontal transport cart (transport robot, moving body)

4 Delivering cart (transport robot, moving body)

5 Work robot

6 Elevator/lift

10 Integrated management system

12 Management terminal (route setting unit, control unit)

14 Management server (route setting unit, control unit)

16 The Internet (public network)

20 Route map

22 Node

24 Edge

26 Yard

28 Material block

A Work supervisor

1.-5. (canceled)

6. An integrated management system for managing an operation of a moving body capable of moving autonomously and deployed in an area, the integrated management system comprising:
a route map virtually plotted to the area, the route map including two or more nodes and one or more edges each connecting the nodes; and
a processor configured to
set a route for causing the moving body to move from one of the nodes to another one of the nodes designated as a destination via at least one of the edges, and
control the moving body to move along the route.

7. The integrated management system according to claim 6, wherein the processor is configured to generate command information for causing the moving body to move along the route, and
the moving body is configured to
receive the command information, and
start moving along the route based on the command information.

8. The integrated management system according to claim 6, wherein
the processor is configured to generate
movement command information for causing the moving body to move along the set route, and
operation command information for causing the moving body to make an operation at a predetermined one of the nodes or a predetermined one of the edges, and
the moving body is configured to
receive the movement command information and the operation command information,
start moving along the route based on the movement command information, and
operate at the predetermined one of the nodes or the predetermined one of the edges based on the operation command information.

9. The integrated management system according to claim 6, wherein the processor is configured to
select a route that minimizes the distance or the time of movement from a plurality of routes, and
set the selected route as the route for causing the moving body to move.

10. The integrated management system according to claim 6, wherein the moving body is a transport robot configured to
transport a load, and
be controlled to move from one of the nodes indicating a location of a transport source to another one of the nodes indicating a location of a transport destination.
